(19) United States
(12) Patent Application Publication
(10) Pub. No.: US 2021/0408849 A1
(43) Pub. Date: Dec. 30, 2021

(54) ROTARY ELECTRIC MACHINE STATOR CORE AND MANUFACTURING METHOD THEREFOR

(71) Applicant: Mitsubishi Electric Corporation, Chiyoda-ku, Tokyo (JP)

(72) Inventors: Kohei Egashira, Tokyo (JP); Tatsuro Hino, Tokyo (JP); Atsuki Hashiguchi, Tokyo (JP); Masashi Nakamura, Tokyo (JP)

(73) Assignee: Mitsubishi Electric Corporation, Chiyoda-ku, Tokyo (JP)

(21) Appl. No.: 16/467,811

(22) PCT Filed: Nov. 30, 2017
(86) PCT No.: PCT/JP2017/043106

§ 371 Date: Jun. 7, 2019

(30) Foreign Application Priority Data
Dec. 15, 2016 (JP) 2016-243087

(51) Int. Cl. H02K 1/18; H02K 1/16; H02K 15/02; H02K 15/12

(52) U.S. Cl. CPC H02K 1/185; H02K 15/12; H02K 15/024; H02K 1/16

(57) ABSTRACT

A rotary electric machine stator core according to the present invention includes: a laminated core in which a plurality of teeth are arranged circumferentially so as to each protrude radially inward from an inner circumferential surface of an annular back yoke; and a plurality of rib members that each have a bolt passage portion, that are joined to an outer circumferential surface of the laminated core such that a bolt insertion direction of the bolt passage portion is oriented in an axial direction, and that are disposed so as to be spaced apart from each other in a circumferential direction.

### TECHNICAL FIELD

The present invention relates to a rotary electric machine stator core for a generator, or an electric motor, etc., and to a manufacturing method therefor, and particularly relates to a stator core in which fixing rib members are disposed on an outer circumferential portion.

### BACKGROUND ART

Conventional rotary electric machine stator cores have included: a stator frame; and a stator core that is configured into an annular shape by laminating magnetic steel sheets, the stator core being fitted into and fixed to an inner peripheral portion of the stator frame, and a plurality of supporting ribs that support the stator core on the inner peripheral portion of the stator frame have been disposed around a circumference of an outer peripheral portion of the stator core (see Patent Literature 1, for example).

Other conventional rotary electric machine stator cores have been configured into an annular shape by laminating magnetic steel sheets in which a plurality of fixing portions that have bolt apertures are disposed around a circumference of an outer circumferential portion (see Patent Literature 2, for example).

### CITATION LIST

### Patent Literature

Patent Literature 1: Japanese Patent Laid-Open No. 2002-281698 (Gazette)

Patent Literature 2: Japanese Patent Laid-Open No. 2008-278695 (Gazette)

### SUMMARY OF THE INVENTION

### Problem to be Solved by the Invention

In conventional rotary electric machine stator cores, because it is necessary to add mounting mechanisms for mounting the stator cores onto external parts such as cases, etc., one problem has been that the number of parts is increased, increasing costs.

In other conventional rotary electric machine stator cores, because the laminated magnetic steel plates have been fixed to each other by crimping, one problem has been that axial strength of the core is reduced. In addition, because a plurality of fixing portions that have bolt apertures have been disposed around the circumference of the outer peripheral portions of the magnetic steel sheets, another problem has been that the yield of the magnetic steel sheets is reduced, increasing costs.

The present invention aims to solve the above problems and an object of the present invention is to provide a rotary electric machine stator core that has high rigidity at low cost, and to provide a manufacturing method therefor.

### Means for Solving the Problem

A rotary electric machine stator core according to the present invention includes: a laminated core in which a plurality of teeth are arranged circumferentially so as to each protrude radially inward from an inner circumferential surface of an annular back yoke; and a plurality of rib members that each have a bolt passage portion, that are joined to an outer circumferential surface of the laminated core such that a bolt insertion direction of the bolt passage portion is oriented in an axial direction, and that are disposed so as to be spaced apart from each other in a circumferential direction.

### Effects of the Invention

According to the present invention, because the rib members that function as fixing portions are constituted by separate members from the laminated core, materials yield for producing the laminated core can be increased, enabling costs to be reduced.

The solid-body rib members are joined to the outer circumferential surface of the laminated core. Thus, rigidity in the axial direction of the laminated core is increased by the solid-body rib members. In addition, it is not necessary to add mounting mechanisms for mounting the stator cores onto external parts such as cases, etc., enabling reductions in the number of parts to be achieved, and also enabling costs to be reduced.

### BRIEF DESCRIPTION OF THE DRAWINGS

FIG. 1 is a half section that shows a rotary electric machine according to Embodiment 1 of the present invention;

FIG. 2 is an oblique projection that shows part of the rotary electric machine according to Embodiment 1 of the present invention;

FIG. 3 is an end elevation that shows a stator core according to Embodiment 1 of the present invention;

FIG. 4 is an oblique projection that shows a rib member of the stator core according to Embodiment 1 of the present invention;

FIG. 5 is an oblique projection that shows a laminated core of the stator core according to Embodiment 1 of the present invention;

FIG. 6 is a side elevation that shows the stator core according to Embodiment 1 of the present invention;

FIG. 7 is a side elevation that shows a variation of the stator core according to Embodiment 1 of the present invention;

FIG. 8 is an oblique projection that shows a rib member according to Embodiment 2 of the present invention;

FIG. 9 is an end elevation that shows a stator core according to Embodiment 2 of the present invention;

FIG. 10 is an end elevation that shows a laminated core according to Embodiment 3 of the present invention;

FIG. 11 is an end elevation that shows a rib member according to Embodiment 4 of the present invention when viewed from an axial direction;

FIG. 12 is an end elevation that shows a variation of a rib member that has a radial mounting position reference portion in the stator core of the present invention when viewed from an axial direction;

FIG. 13 is an end elevation that shows a variation of a rib member that has a radial mounting position reference portion in the stator core of the present invention when viewed from an axial direction;

FIG. 14 is an end elevation that shows a variation of a rib member that has a radial mounting position reference portion in the stator core of the present invention when viewed from an axial direction;

FIG. 15 is an end elevation that shows a variation of a rib member that has a radial mounting position reference portion in the stator core of the present invention when viewed from an axial direction;

FIG. 16 is an end elevation that shows a rib member according to Embodiment 5 of the present invention when viewed from an axial direction;

FIG. 17 is a partial cross section that explains a method for welding the rib member according to Embodiment 5 of the present invention to a laminated core;

FIG. 18 is a partial end elevation that shows a vicinity of a positioning groove of a laminated core according to Embodiment 6 of the present invention when viewed from an axial direction;

FIG. 19 is an end elevation that shows a rib member according to Embodiment 6 of the present invention when viewed from an axial direction;

FIG. 20 is a partial end elevation that shows a stator core in a vicinity of the rib member according to Embodiment 6 of the present invention when viewed from an axial direction;

FIG. 21 is a partial end elevation that shows a vicinity of positioning grooves of a laminated core according to Embodiment 7 of the present invention when viewed from an axial direction;

FIG. 22 is an end elevation that shows a rib member according to Embodiment 7 of the present invention when viewed from an axial direction;

FIG. 23 is a partial end elevation that shows a stator core in a vicinity of the rib member according to Embodiment 7 of the present invention when viewed from an axial direction;

FIG. 24 is a diagram that explains a method for mounting a rib member to a laminated core according to Embodiment 8 of the present invention;

FIG. 25 is a partial end elevation that shows a stator core in a vicinity of the rib member according to Embodiment 8 of the present invention when viewed from an axial direction;

FIG. 26 is an end elevation that shows a stator according to Embodiment 9 of the present invention;

FIG. 27 is a partial cross section that shows a weld portion of a stator core according to Embodiment 10 of the present invention;

FIG. 28 is an oblique projection that explains a laminated core manufacturing method according to Embodiment 11 of the present invention;

FIG. 29 is an oblique projection that shows a laminated core according to Embodiment 11 of the present invention;

FIG. 30 is an enlargement of Portion A in FIG. 29;

FIG. 31 is an end elevation that shows a stator core according to Embodiment 11 of the present invention;

FIG. 32 is a side elevation that shows the stator core according to Embodiment 11 of the present invention;

FIG. 33 is an end elevation that shows an outer circumferential core of a stator core according to Embodiment 12 of the present invention;

FIG. 34 is an end elevation that shows a stator core according to Embodiment 12 of the present invention;

FIG. 35 is an oblique projection that explains a stator core assembly method according to Embodiment 12 of the present invention;

FIG. 36 is a flow diagram that shows a stator core manufacturing method according to Embodiment 13 of the present invention;

FIG. 37 is a flow diagram that shows a stator core manufacturing method according to Embodiment 14 of the present invention;

FIG. 38 is a schematic diagram that explains a correcting step in the stator core manufacturing method according to Embodiment 14 of the present invention;

FIG. 39 is a schematic diagram that explains a step of correcting in a stator core manufacturing method according to Embodiment 15 of the present invention;

FIG. 40 is a schematic diagram that explains a step of correcting in a stator core manufacturing method according to Embodiment 16 of the present invention; and

FIG. 41 is a flow diagram that shows a stator core manufacturing method according to Embodiment 17 of the present invention.

### DESCRIPTION OF EMBODIMENTS

Preferred embodiments of a rotary electric machine stator core and a manufacturing method therefor according to the present invention will now be explained with reference to the drawings. Moreover, unless otherwise specified, a circumferential direction, a radial direction, and an axial direction shall be defined using the stator or the rotary electric machine as a cylindrical coordinate system, the axial direction being direction along a central axis of a rotating shaft of a rotor, the circumferential direction being a direction of rotation of the rotating shaft, and the radial direction being a direction of a radius of the rotating shaft.

### Embodiment 1

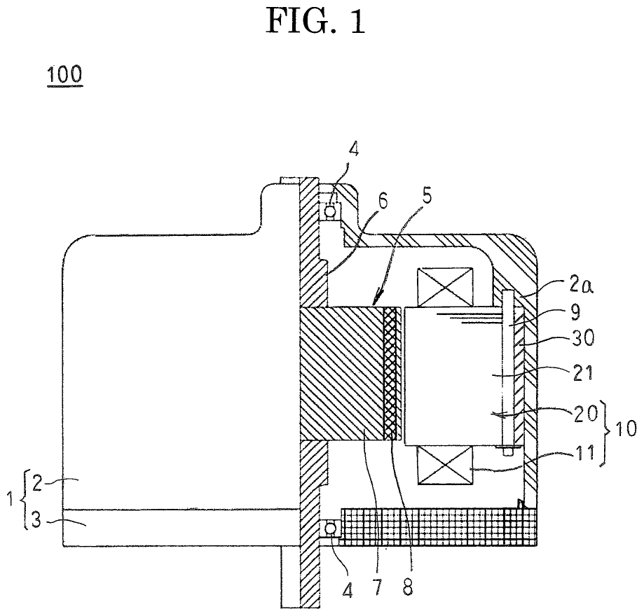

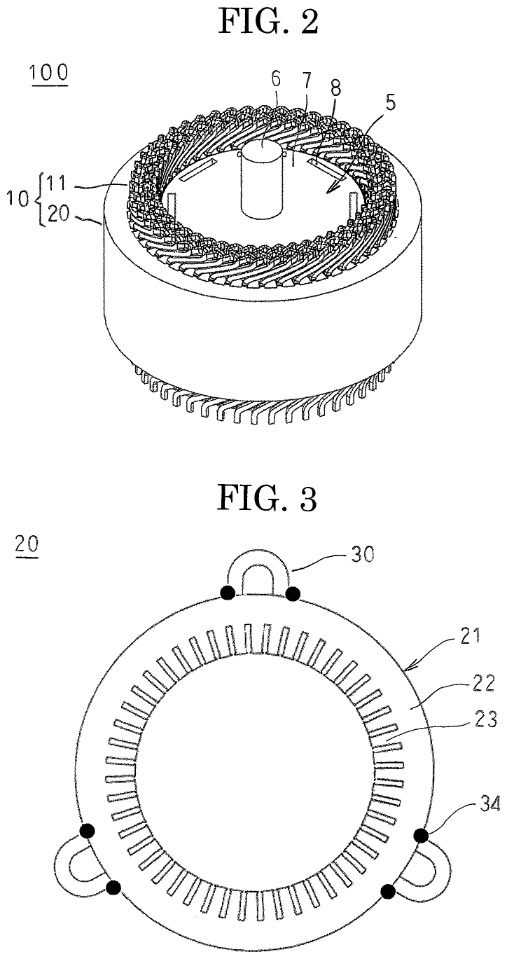

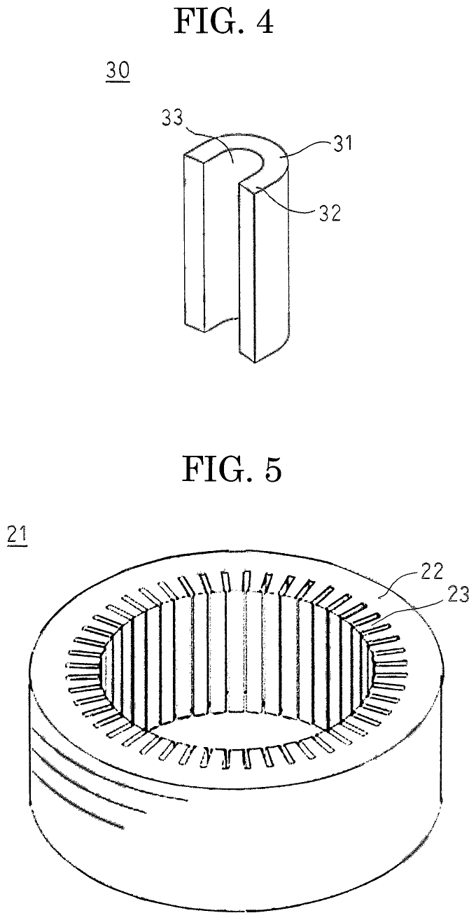

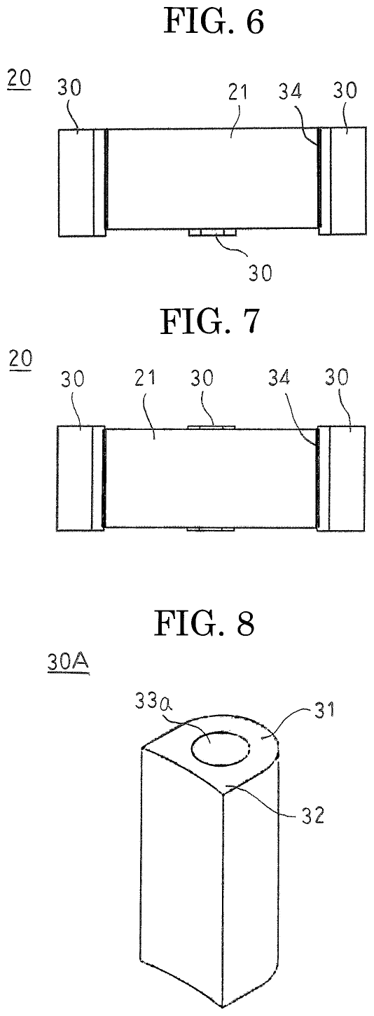

FIG. 1 is a half section that shows a rotary electric machine according to Embodiment 1 of the present invention, FIG. 2 is an oblique projection that shows part of the rotary electric machine according to Embodiment 1 of the present invention, FIG. 3 is an end elevation that shows a stator core according to Embodiment 1 of the present invention, FIG. 4 is an oblique projection that shows a rib member of the stator core according to Embodiment 1 of the present invention, FIG. 5 is an oblique projection that shows a laminated core of the stator core according to Embodiment 1 of the present invention, FIG. 6 is a side elevation that shows the stator core according to Embodiment 1 of the present invention, and FIG. 7 is a side elevation that shows a variation of the stator core according to Embodiment 1 of the present invention. Moreover, for simplicity, rib members that are fixed to an outer circumferential surface of a stator core have been omitted from FIG. 2.

In FIGS. 1 and 2, a rotary electric machine 100 includes: a housing 1 that has: a floored cylindrical frame 2; and an end plate 3 that closes the frame 2; a stator 10 that is inserted inside and fixed to a cylindrical portion of the frame 2; and a rotor 5 that is fixed to a rotating shaft 6 that is rotatably supported in the floor portion of the frame 2 and the end plate 3 by means of bearings 4 so as to be rotatably disposed on an inner circumferential side of the stator 10.

The rotor 5 is a permanent-magnet rotor that includes: a rotor core 7 that is fixed to the rotating shaft 6, which is inserted so as to pass through a central position thereof; and permanent magnets 8 that are embedded in a vicinity of an outer circumferential surface of the rotor core 7 so as to be arranged at a uniform pitch circumferentially to constitute magnetic poles. Moreover, the rotor 5 is not limited to a permanent-magnet rotor, and a squirrel-cage rotor in which uninsulated rotor conductors are housed in slots of a rotor core such that two sides are shorted by a shorting ring, or a wound rotor in which insulated conductor wires are mounted into slots of a rotor core, etc., may be used.

The stator 10 includes: a stator core 20 that is produced using a magnetic material; and a stator winding 11 that is produced by winding electrically conductive coils. As shown in FIG. 3, the stator core 20 includes: an annular laminated core 21 that is produced by axially laminating annular core strips that are punched out of a magnetic steel sheet such as an electromagnetic steel sheet by a press, and fixing together the laminated core strips by a fixing means such as crimping, welding, gluing, etc.; and rib members 30 that are fixed to an outer circumferential surface of the laminated core 21. As shown in FIG. 5, the laminated core 21 includes: an annular back yoke 22; and a plurality of teeth 23 that are arranged at a uniform pitch circumferentially so as to each protrude radially inward from an inner circumferential surface of a back yoke 22. Although not shown, electrical insulation between the stator core 20 and the stator winding 11 is ensured by mounting insulating papers between the stator core 20 and the stator winding 11. In this case, insulating papers have been used, but an electrically insulating resin may be formed integrally on the stator core 20 using injection molding so as to cover an entire surface of the stator core 20.

As shown in FIG. 4, the rib members 30 are produced into U-shaped prisms using a solid body of metal, and include: a fixing portion 31 on which a bolt passage portion 33 is formed; and joining portions 32. Three rib members 30 are arranged at a pitch of 120 degrees circumferentially so as to each be disposed on an outer circumferential surface of the laminated core 21 so as to a have a longitudinal direction of the prism oriented in an axial direction, the joining portions 32 being joined to the laminated core 21 by laser welding. As shown in FIG. 3, the rib members 30 are joined to the laminated core 21 firmly by laser welding, and bead portions 34 are formed so as to extend from a first end to the second end in the axial direction of the laminated core 21.

The stator 10 that is configured in this manner is inserted inside the cylindrical portion of the frame 2. Then the stator 10 is fixed to the frame 2 by inserting through-bolts 9 into the bolt passage portions 33, and fastening the through-bolts 9 to fixing portions 2a that protrude radially inward from an inner wall surface of the frame 2 in a vicinity of the floor portion of the cylindrical portion. Here, it is preferable for lengths of the rib members 30 to be made longer than an axial length of the laminated core 21. As shown in FIG. 6, the rib members 30 are mounted to the laminated core 21 such that first end surfaces thereof are flush with a first axial end surface of the laminated core 21 and second ends thereof protrude outward from the laminated core 21 at a second axial end. Furthermore, as shown in FIG. 7, the rib members 30 may alternatively be mounted to the laminated core 21 such that both end portions thereof protrude at both axial ends of the laminated core 21.

In Embodiment 1, a stator core 20 includes: an annular laminated core 21; and rib members 30 that are welded onto an outer circumferential surface of the laminated core 21. Thus, because the laminated core 21 is configured by laminating core strips that have been punched from thin magnetic steel sheet, reductions in eddy current loss can be achieved. Because rib members 30, which constitute fixing members, are constituted by separate members from the laminated core 21, the core strips can be punched into an annular shape from the magnetic steel sheet, enabling yield, which is the utilization rate of the magnetic steel sheet, to be increased. Because the solid-body rib members 30 are welded onto the outer circumferential surface of the laminated core 21 so as to extend from a first axial end to a second axial end, rigidity is increased in the axial direction of the laminated core 21.

The rib members 30 are mounted to the laminated core 21 such that first end surfaces thereof are flush with the first axial end surface of the laminated core 21 and second ends thereof protrude outward from the laminated core 21 at a second axial end. Thus, the core strips that are positioned at both axial end portions of the laminated core 21 are reliably joined together, increasing rigidity in the axial direction of the laminated core 21.

Because the rib members 30 have a simple U shape, they can be produced by press molding, etc., from a solid body of metal, enabling reductions in cost and increases in yield to be achieved.

Moreover, in Embodiment 1 above, laser welding has been used as the joining means between the rib members 30 and the laminated core 21, but tungsten-inert gas (TIG) welding or brazing may be used. Furthermore, TIG welding or brazing may also be used instead of laser welding in other embodiments in which rib members and a laminated core are joined by laser welding.

### Embodiment 2

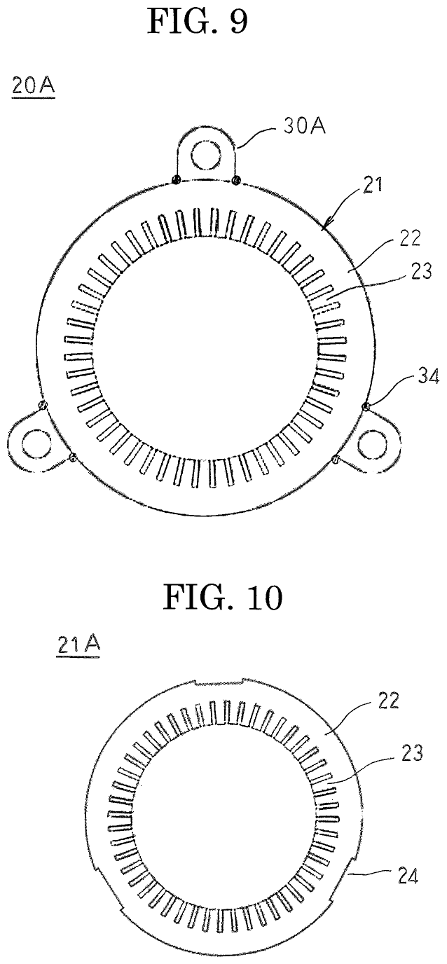

FIG. 8 is an oblique projection that shows a rib member according to Embodiment 2 of the present invention, and FIG. 9 is an end elevation that shows a stator core according to Embodiment 2 of the present invention.

In FIGS. 8 and 9, rib members 30A are produced into prisms using solid bodies of metal, and bottom surfaces of joining portions 32 are formed so as to have a curved surface shape that conforms to a surface shape of an outer circumferential surface of a laminated core 21. Bolt passage portions 33a are formed so as to pass through the rib members 30A in a longitudinal direction thereof. Three rib members 30 are arranged at a pitch of 120 degrees circumferentially so as to each be disposed on an outer circumferential surface of the laminated core 21 so as to a have longitudinal direction oriented axially, and so as to be joined to the laminated core 21 by laser welding.

A stator core 20A is configured in a similar or identical manner to that of the stator core 20 in Embodiment 1 above except that the rib members 30A are used instead of the rib members 30. Consequently, similar or identical effects to those in Embodiment 1 above can also be achieved in Embodiment 2.

In Embodiment 2, bottom surfaces of joining portions 32 that constitute mounting surfaces of rib members 30A have a curved surface shape that conforms to a surface shape of an outer circumferential surface of a laminated core 21. Thus, because the rib members 30A can be installed in a stable state in which the bottom surfaces of the joining portions 32 contact the outer circumferential surface of the laminated core 21, joining workability is improved, and stable joining strength is also achieved.

### Embodiment 3

FIG. 10 is an end elevation that shows a laminated core according to Embodiment 3 of the present invention.

In FIG. 10, positioning grooves 24 are formed on an outer circumferential surface of a laminated core 21A at positions of installation of rib members 30 so as to have groove directions oriented in an axial direction. The positioning grooves 24 are formed so as to have groove shapes that have oblong cross sections that conform to the shapes of joining portions 32 of the rib members 30, and are formed simultaneously on outer circumferences of core strips in a step of punching annular core strips from a magnetic steel sheet, for example.

In Embodiment 3, the joining portions 32 are fitted into the positioning grooves 24, and the rib members 30 are joined to the laminated core 21A by laser welding.

Consequently, similar or identical effects to those in Embodiment 1 above can also be achieved in Embodiment 3.

According to Embodiment 3, because the positioning grooves 24 are formed on the outer circumferential surface of the laminated core 21A, positioning of the rib members 30 is facilitated. In addition, precision of the positions of installation of the rib members 30 can be increased by increasing the machining precision of the positioning grooves 24.

Moreover, in Embodiment 3 above, the groove shapes of the positioning grooves 24 are groove shapes that have oblong cross sections that conform to the shapes of joining portions 32 of the rib members 30 in Embodiment 1, but the groove shapes of the positioning grooves 24 may alternatively be groove shapes that conform to the shapes of joining portions of the rib members in other embodiments. The precision of the positions of installation of the rib members in other embodiments can thereby be increased.

In Embodiment 3 above, the rib members 30 are mounted to the laminated core 21A by laser welding, but the rib members 30 may alternatively be mounted to the laminated core 21A so as to be press-fitted into the positioning grooves 24 or fitted into the positioning grooves 24 and then fixed by crimping.

Alternatively, the rib members 30 may be fixed by being press-fitted into the positioning grooves 24, or the rib members 30 may be fitted into the positioning grooves 24 and fixed by crimping, and then the rib members 30 may be laser-welded to the laminated core 21A. Axial rigidity of the laminated core 21A can thereby be further increased. The rib members 30 are also already fixed to the laminated core 21A while laser-welding, improving joining workability, and also achieving stable joining strength.

### Embodiment 4

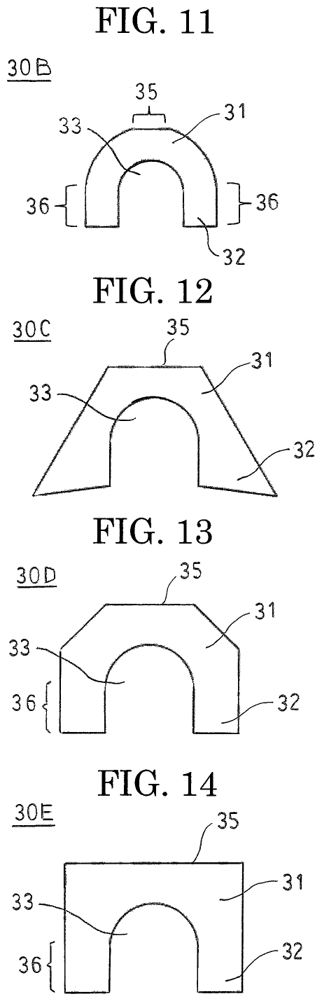

FIG. 11 is an end elevation that shows a rib member according to Embodiment 4 of the present invention when viewed from an axial direction.

In FIG. 11, a rib member 30B is produced into a U-shaped prism using a solid body of metal, and includes: a fixing portion 31 on which a bolt passage portion 33 is formed; and joining portions 32. A first flat surface 35 is formed on an outer circumferential surface of an apex portion of the fixing portion 31. Second flat surfaces 36 are formed on two circumferential side surfaces of the joining portions 32.

Here, the first flat surface 35, which functions as a radial mounting position reference portion, is formed into a flat surface that is tangential to a cylindrical plane that has an axial center of a laminated core 21 as a central axis in a state in which the rib member 30B is welded and fixed to the outer circumferential surface of the laminated core 21. The second flat surfaces 36, which function as circumferential mounting position reference portions, are formed into flat surfaces that are positioned on planes that include the axial center of the laminated core 21 in the state in which the rib member 30B is welded and fixed to the outer circumferential surface of the laminated core 21.

Because Embodiment 4 is configured in a similar or identical manner to Embodiment 1 above except that the rib members 30B are used, similar effects to those in Embodiment 1 above can be achieved.

In Embodiment 4, the first flat surfaces 35 are tangential to a cylindrical plane that is centered around the axial center of the laminated core 21. Thus, because the stator core can be mounted to an external member such as a case using the first flat surfaces 35 as reference surfaces, radial mounting positioning accuracy of the stator core can be improved.

The second flat surfaces 36 are positioned on planes that include the axial center of the laminated core 21. Thus, because the rib members 30B can be mounted to the laminated core 21 using the second flat surfaces 36 as reference surfaces, circumferential mounting positioning accuracy of the rib members 30B can be improved. In addition, because the stator core can be mounted to an external member using the second flat surfaces 36 as reference surfaces, circumferential mounting positioning accuracy of the stator core can be improved.

Moreover, in Embodiment 4 above, the second flat surfaces 36 are formed on two circumferential side surfaces of the joining portions 32 of the rib members 30B, but a second flat surface 36 need only be formed on one circumferential side surface of the rib members 30B.

In Embodiment 4 above, the first flat surfaces 35 and the second flat surfaces 36 are formed on the rib members 30 in Embodiment 1, but similar or identical effects can also be achieved if the first flat surfaces 35 and the second flat surfaces 36 are formed on rib members in other embodiments.

Variations of rib members that have radial mounting position reference portions will now be explained using FIGS. 12 through 15. FIGS. 12 through 15 are respective end elevations that show a variation of a rib member that has a radial mounting position reference portion in the stator core of the present invention when viewed from an axial direction.

Rib members 30C through 30E, which are shown in FIGS. 12 through 14, are produced into polygonal prisms using solid bodies of metal, and include: a fixing portion 31 on which a bolt passage portion 33 is formed; and joining portions 32. First flat surfaces 35 that function as radial mounting reference portions that are constituted by flat surfaces that are tangential to a cylindrical plane that has an axial center of a laminated core as a central axis in the state in which the rib members 30C through 30E are joined to the laminated core are formed on outer circumferential surfaces of apex portions of the fixing portions 31.

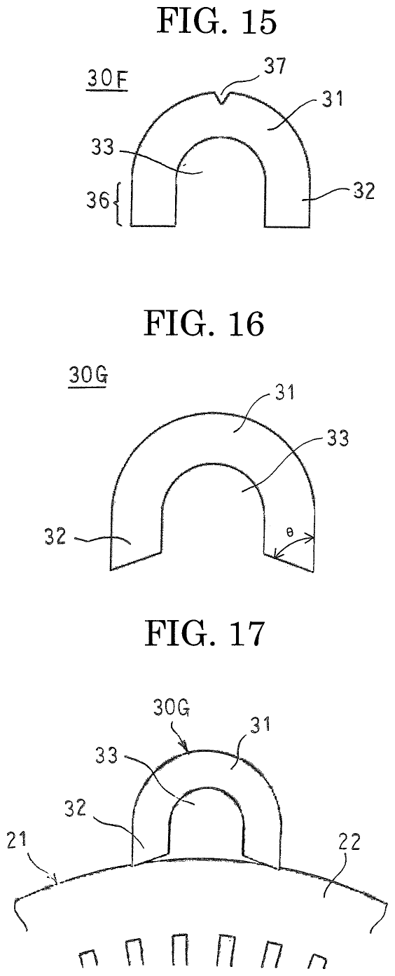

A rib member 30F, which is shown in FIG. 15, is produced into a U-shaped prism using a solid body of metal, and includes: a fixing portion 31 on which a bolt passage portion 33 is formed; and joining portions 32. A V-shaped notch 37 that functions as a radial mounting position reference portion is formed on an apex portion of an outer circumferential surface of the fixing portion 31 so as to have a groove direction oriented in an axial direction so as to extend from a first axial end to a second axial end.

Second flat surfaces 36 that function as circumferential mounting reference portions are formed on one or two circumferential side surfaces of the joining portions 32 of the rib members 30D through 30F.

Radial mounting positioning accuracy of the stator core can also be improved if the rib members 30C through 30F that are configured in this manner are used instead of the rib members 30B.

In addition, circumferential mounting positioning accuracy of the stator core can also be improved if the rib members 30D through 30F that are configured in this manner are used instead of the rib members 30B.

### Embodiment 5

FIG. 16 is an end elevation that shows a rib member according to Embodiment 5 of the present invention when viewed from an axial direction, and FIG. 17 is a partial cross section that explains a method for welding the rib member according to Embodiment 5 of the present invention to a laminated core.

In FIG. 16, a rib member 30G is produced into a U-shaped prism using a solid body of metal, and includes: a fixing portion 31 on which a bolt passage portion 33 is formed; and joining portions 32. A joining portion angle θ, which is an angle between an inner circumferential surface and an outer surface in the circumferential direction of a joining portion 32, is an acute angle.

Moreover, the rib member 30G is configured in a similar or identical manner to that of the rib member 30 in Embodiment 1 except that the joining portion angle θ is an acute angle.

As shown in FIG. 17, only corner portions between the inner circumferential surfaces and the outer surfaces in the circumferential direction of the joining portions 32 of the rib members 30G that are configured in this manner are in a state of contact with the outer circumferential surface of the laminated core 21. By placing the rib members 30G and the laminated core 21 in contact along a line that extends in an axial direction in this manner, the rib members 30C and the laminated core 21 can be placed in contact in a stable state, enabling stable weld strength to be achieved.

Moreover, in Embodiment 5 above, the joining portion angles θ of the rib members 30 from Embodiment 1 are made into acute angles, but similar or identical effects can also be achieved if the joining portion angles of the rib members in other embodiments are made into acute angles.

### Embodiment 6

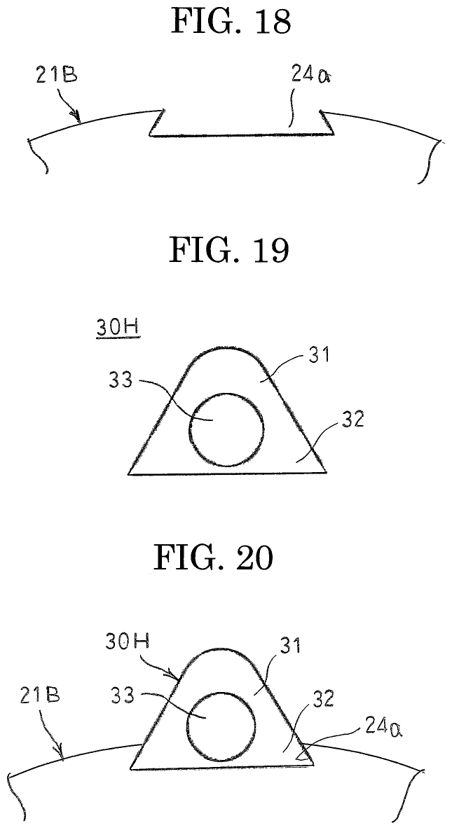

FIG. 18 is a partial end elevation that shows a vicinity of a positioning groove of a laminated core according to Embodiment 6 of the present invention when viewed from an axial direction, FIG. 19 is an end elevation that shows a rib member according to Embodiment 6 of the present invention when viewed from an axial direction, and FIG. 20 is a partial end elevation that shows a stator core in a vicinity of the rib member according to Embodiment 6 of the present invention when viewed from an axial direction.

In FIGS. 18 and 19, a positioning groove 24a that has a dovetail groove shape has a groove direction in an axial direction, and is formed on an outer circumferential surface of a laminated core 21B so as to extend from a first axial end to a second axial end. A rib member 30H is produced into a prism that has a dovetail shape that is slightly larger than the dovetail groove shape of the positioning groove 24a using a solid body of metal, and includes: a fixing portion 31 on which a bolt passage portion 33 is formed; and a joining portion 32.

As shown in FIG. 20, the rib member 30H is mounted to the laminated core 21B so as to be press-fitted into the positioning groove 24a from the axial direction. The rib member 30H and the laminated core 21B are thereby coupled firmly, and rigidity is increased in the axial direction of the laminated core 21B.

Moreover, the rib member 30H and the laminated core 21B may be laser-welded after the rib member 30H is press-fitted into the positioning groove 24a. In that case, the rib member 30H is mounted to the laminated core 21B in a stable state, enabling stable weld strength to be achieved.

### Embodiment 7

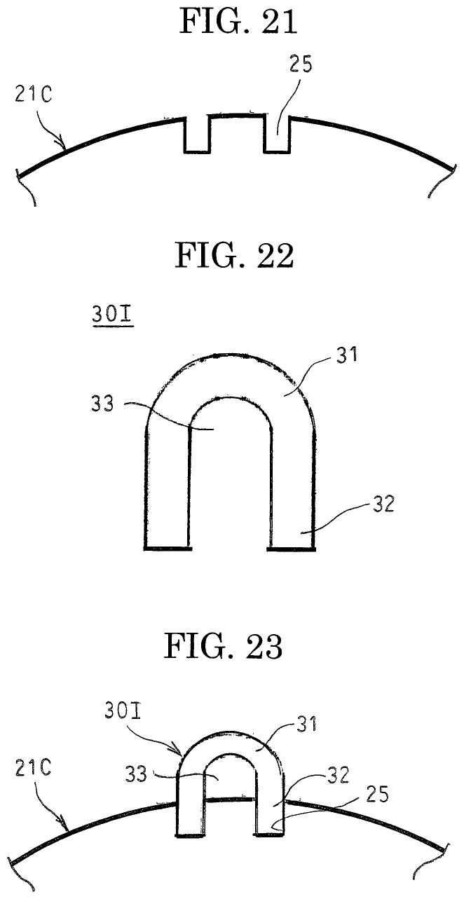

FIG. 21 is a partial end elevation that shows a vicinity of positioning grooves of a laminated core according to Embodiment 7 of the present invention when viewed from an axial direction, FIG. 22 is an end elevation that shows a rib member according to Embodiment 7 of the present invention when viewed from an axial direction, and FIG. 23 is a partial end elevation that shows a stator core in a vicinity of the rib member according to Embodiment 7 of the present invention when viewed from an axial direction.

In FIGS. 21 and 22, two positioning grooves 25 are formed on an outer circumferential surface of a laminated core 21C so as to be mutually parallel and spaced apart in a circumferential direction. Each of the positioning grooves 25 has a groove shape that has a rectangular cross section, and is formed so as to have a groove direction oriented in an axial direction so as to extend from a first axial end to a second axial end. A rib member 30I is produced into a U-shaped prism using a solid body of metal, and includes: a fixing portion 31 on which a bolt passage portion 33 is formed; and joining portions 32. The joining portions 32, which constitute leg portions, are formed so as to have widths that are slightly larger than groove widths of the positioning grooves 25.

As shown in FIG. 23, the rib member 30I is mounted to the laminated core 21C by press-fitting the joining portions 32 into the positioning grooves 25 from radially outside. The rib member 30I and the laminated core 21C are thereby coupled firmly, and rigidity is increased in the axial direction of the laminated core 21C.

Moreover, the rib member 30I and the laminated core 21C may be laser-welded after the rib member 30I is press-fitted into the positioning grooves 25. In that case, the rib member 30I is mounted to the laminated core 21C in a stable state, enabling stable weld strength to be achieved.

### Embodiment 8

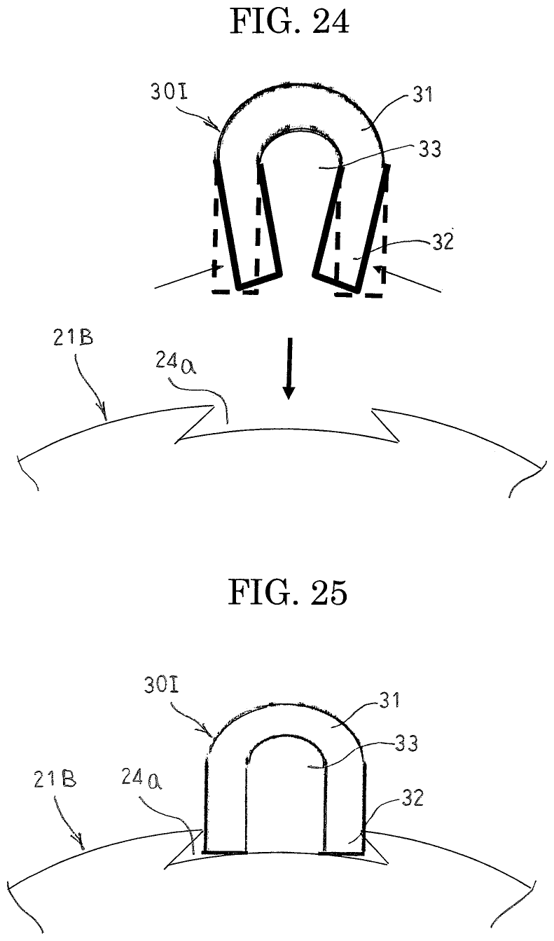

FIG. 24 is a diagram that explains a method for mounting a rib member to a laminated core according to Embodiment 8 of the present invention, and FIG. 25 is a partial end elevation that shows a stator core in a vicinity of the rib member according to Embodiment 8 of the present invention when viewed from an axial direction.

In Embodiment 8, a distance between outer side surfaces of joining portions 32 that constitute a pair of leg portions of a rib member 30I is slightly larger than a circumferential width of an opening of a positioning groove 24a. In order to mount the rib member 30I into the positioning groove 24a, the pair of joining portions 32 of the rib member 30I are elastically deformed by applying pressure to two sides such that vicinities of tips of the pair of joining portions 32 approach each other, as shown in FIG. 24. Then, in the state in which the vicinities of the tips of the pair of joining portions 32 are elastically deformed so to approach each other, the pair of joining portions 32 of the rib member 30I are inserted into the positioning groove 24a until they contact the floor portion of the positioning groove 24a. When the pair of joining portions 32 of the rib member 30I contact the floor portion of the positioning groove 24a, pressure on the pair of joining portions 32 is released. Thus, the pair of joining portions 32 of the rib member 30I recover and are fitted into the positioning groove 24a, and the rib member 30I is mounted to the laminated core 21B as shown in FIG. 25. This step corresponds to a rib member joining step (Step 202) that is described below.

The rib member 30I and the laminated core 21B are thereby coupled firmly, increasing rigidity of the laminated core 21B in the axial direction. Furthermore, because the joining portions 32 of the rib member 30I are not press-fitted into the positioning groove 24a, contamination by foreign matter that results from the rib member 30I and the laminated core 21B being scraped off is prevented.

Moreover, the rib member 30I and the laminated core 21B may be laser-welded after the rib member 30I is mounted into the positioning groove 24a. In that case, the rib member 30I is mounted to the laminated core 21B in a stable state, enabling stable weld strength to be achieved.

Furthermore, in Embodiment 8, a positioning groove 24a that has a dovetail groove shape is formed on the laminated core, but a positioning groove 24 that has an oblong cross section may alternatively be formed on the laminated core.

### Embodiment 9

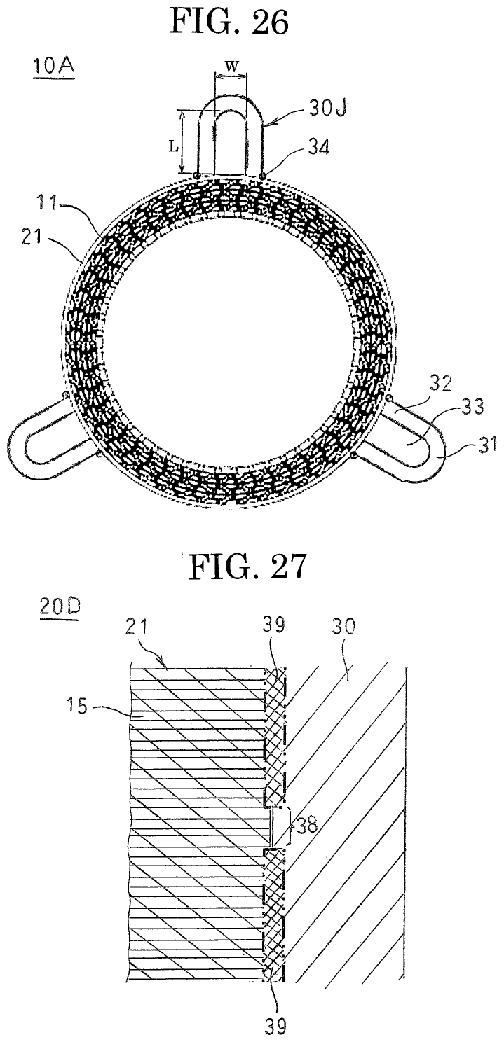

FIG. 26 is an end elevation that shows a stator according to Embodiment 9 of the present invention.

In FIG. 26, rib members 30J are produced into U-shaped prisms using solid bodies of metal, and include: a fixing portion 31 on which a bolt passage portion 33 is formed; and joining portions 32, a radial length L of the bolt passage portion 33 being longer than a circumferential width W thereof.

In Embodiment 9, because the radial length L of the bolt passage portion 33 of the rib member 30J is longer than the circumferential width W thereof, through-bolts 9 for mounting the stator 10A onto an external member that are passed through the bolt passage portions 33 can be spaced radially outward from the laminated core 21. Thus, contact between the through-bolts 9 and the stator winding 11 is prevented when mounting the stator 10A to the external member, enabling the occurrence of damage to the stator winding 11 to be suppressed.

Now, if the rib members 30J are formed integrally on annular core strips that constitute the laminated core 21, then the amount of protrusion of the rib members from the core strips is increased, reducing the yield of the magnetic steel sheet. In Embodiment 9, because the rib members 30J are constituted by separate members from the core strips, yield loss of the magnetic steel sheet is suppressed, enabling reductions in the cost of the stator 10A to be achieved.

### Embodiment 10

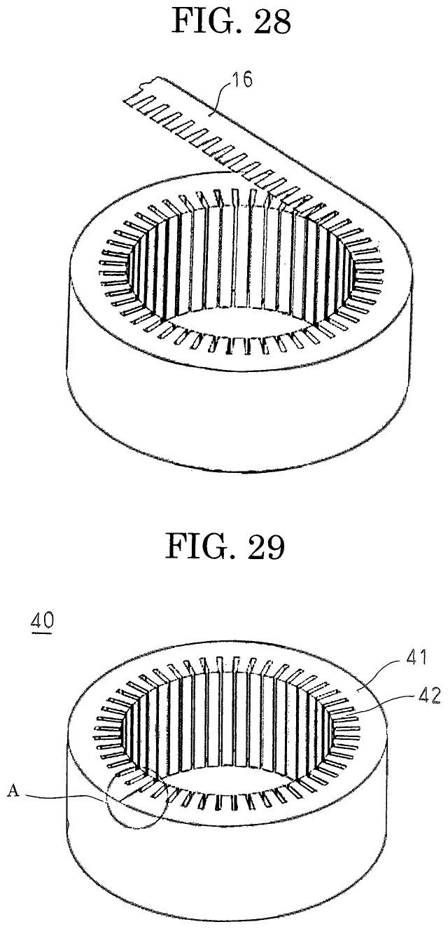

FIG. 27 is a partial cross section that shows a weld portion of a stator core according to Embodiment 10 of the present invention.

In FIG. 27, weld portions 39 between annular core strips 15 that constitute a laminated core 21 and a rib member 30 are formed over not quite entire axial regions of the laminated core 21. In other words, a non-welded portion 38 remains between the weld portions 39.

In a stator core 20D that is configured in this manner, the laminated core 21 and the rib member 30 are welded discontinuously in an axial direction. An extremely small air gap is formed between the core strips 15 and the rib member 30 at the non-welded portion 38, electrically insulating the core strips 15 and the rib member 30. An electrical short-circuiting region between the laminated core 21 and the rib member 30 is thereby reduced in the axial direction, reducing eddy current loss for the stator.

Moreover, in Embodiment 10 above, one non-welded portion 38 is disposed in the axial direction, but a plurality of non-welded portions 38 may alternatively be disposed in the axial direction.

Furthermore, Embodiment 10 above has been applied to a weld portion between the laminated core 21 and the rib member 30 in Embodiment 1, but similar or identical effects can also be achieved if applied to weld portions between laminated cores and rib members in other embodiments.

### Embodiment 11

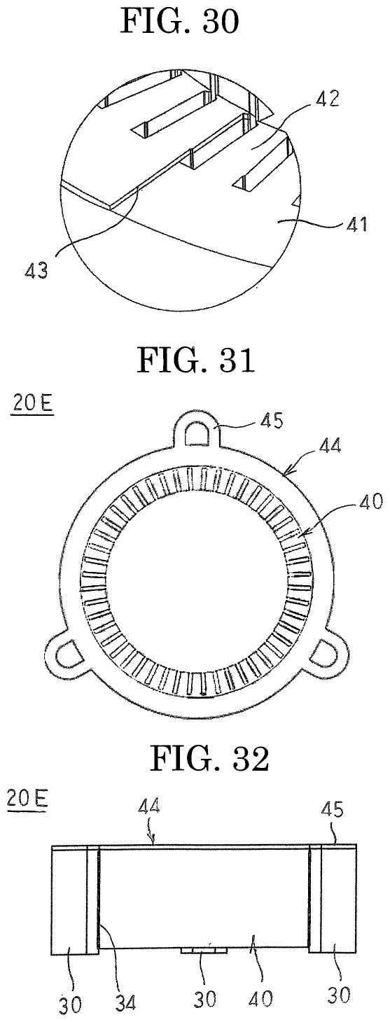

FIG. 28 is an oblique projection that explains a laminated core manufacturing method according to Embodiment 11 of the present invention, FIG. 29 is an oblique projection that shows a laminated core according to Embodiment 11 of the present invention, FIG. 30 is an enlargement of Portion A in FIG. 29, FIG. 31 is an end elevation that shows a stator core according to Embodiment 11 of the present invention, and FIG. 32 is a side elevation that shows the stator core according to Embodiment 11 of the present invention.

In FIGS. 28 through 32, a stator core 20E includes: an annular laminated core 40 that is produced by winding into a helical shape a belt-shaped core strip 16 that is punched out of a magnetic steel sheet such as an electromagnetic steel sheet, and joining together and integrating the core strip 16 by a fixing means such as crimping, welding, brazing, gluing, etc.; an annular end plate 44 that is fixed to a first axial end surface of the laminated core 40; and rib members 30 that are fixed by welding to an outer circumferential surface of the laminated core 40. The laminated core 40 includes: an annular back yoke 41; and a plurality of teeth 42 that are arranged at a uniform pitch circumferentially so as to each protrude radially inward from an inner circumferential surface of a back yoke 41. Three rib members 30 are disposed in a circumferential direction, and are welded onto an outer circumferential surface of the laminated core 40 such that first axial end surfaces thereof are flush with the first axial end surface of the laminated core 40. The end plate 44 is produced by punching a magnetic steel sheet that has a greater sheet thickness than the core strip 16 into a similar annular shape to that of the back yoke 41. In addition, fixing portions 45 that correspond to the rib members 30 are punched out of the magnetic steel sheet together with the end plate 44.

As shown in FIGS. 29 and 30, a step 43 is formed on the first axial end surface of the laminated core 40 that is configured in this manner by the end portion of the core strip 16. In Embodiment 11, because the end plate 44 is disposed on the first axial end surface of the laminated core 40, a first axial end surface of the stator core 20E can be formed into a flat surface.

Because the sheet thickness of the end plate 44 is thicker than the core strip 16 that constitutes the laminated core 40, rigidity can be increased in the axial direction of the stator core 20E.

Because the laminated core 40 is configured by laminating a belt-shaped core strip 16 into a helical shape, yield of the magnetic steel sheet can be increased.

Moreover, in Embodiment 11 above, the end plate 44 is disposed on the first axial end surface of the laminated core 40, but end plates 44 may be disposed on two axial end surfaces of the laminated core 40.

In Embodiment 11 above, the fixing portions 45 are formed integrally on the end plate 44, but the fixing portions 45 need not be disposed on the end plate 44. In that case, the end plate 44 should be disposed on the first axial end surface of the laminated core 40, and then the rib members 30 should be welded onto the laminated core 40 on which the end plate 44 is disposed. Here, the rib members 30 should be mounted such that first ends thereof are flush with a first axial end surface of the end plate 44, and second ends thereof protrude outward at a second axial end of the laminated core 40, or such that both ends thereof protrude outward at both axial ends from the laminated core 40 on which the end plate 44 is disposed.

In Embodiment 11 above, the rib members 30 have been used, but similar or identical effects can be achieved using the rib members from other embodiments.

### Embodiment 12

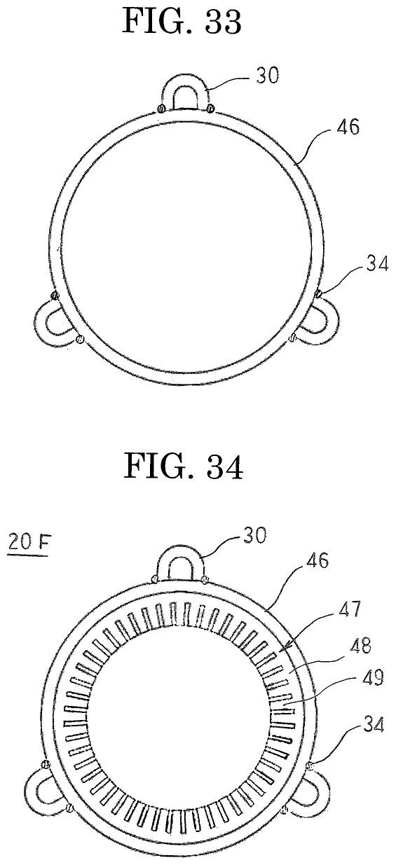

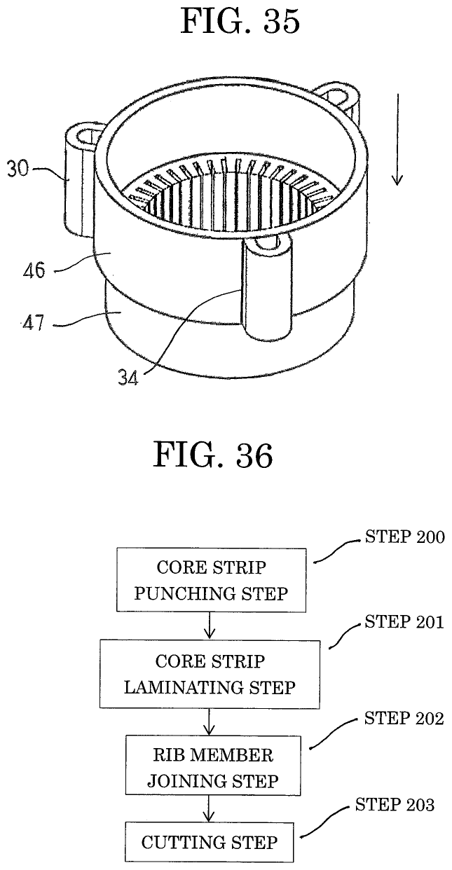

FIG. 33 is an end elevation that shows an outer circumferential core of a stator core according to Embodiment 12 of the present invention, FIG. 34 is an end elevation that shows a stator core according to Embodiment 12 of the present invention, and FIG. 35 is an oblique projection that explains a stator core assembly method according to Embodiment 12 of the present invention.

In FIGS. 33 and 34, a stator core 20F includes: an annular outer circumferential core 46 that is formed by laminating and integrating annular core strips that have been punched from a magnetic steel sheet such as an electromagnetic steel sheet; an annular inner circumferential core 47 that is formed by laminating and integrating annular core strips that have been punched from a magnetic steel sheet that is thinner than the magnetic steel sheet that constitutes the outer circumferential core 46; and three rib members 30 that are welded onto an outer circumferential surface of the outer circumferential core 46 so as to be arranged circumferentially. Here, the inner circumferential core 47 includes: an annular back yoke portion 48; and a plurality of teeth 49 that are disposed circumferentially so as to each protrude radially inward from an inner circumferential surface of a back yoke portion 48.

To produce the stator core 20F that is configured in this manner, the rib members 30 are welded onto the outer circumferential surface of the outer circumferential core 46. Next, as shown in FIG. 35, the stator core 20F is assembled by inserting and fixing the inner circumferential core 47 by press-fitting or shrink-fitting inside the outer circumferential core 46 to which the rib members 30 have been welded. The back yoke of the stator core 20F is constituted by the outer circumferential core 46 and the back yoke portion 48 of the inner circumferential core 47.

Now, roundness of a core depends on punching precision of the annular core strips that are punched out of the magnetic steel sheet. Specifically, the thicker the thickness of the magnetic steel sheet, the higher the roundness of the resulting core. In Embodiment 12, because the inner circumferential core 47 is constituted by laminating thin core strips, eddy current loss can be reduced, but roundness is poor.

According to Embodiment 12, the stator core 20F is constituted by the outer circumferential core 46 and the inner circumferential core 47. Because the outer circumferential core 46 is constituted by laminating core strips that have a greater sheet thickness than the core strips that constitute the inner circumferential core 47, circumferential rigidity of the outer circumferential core 46 is greater than circumferential rigidity of the inner circumferential core 47. Thus, by inserting and fixing the inner circumferential core 47 inside the outer circumferential core 46 by press-fitting or shrink-fitting, the inner circumferential core 47 follows the shape of the outer circumferential core 46, making the roundness of the inner circumferential core 47 equal to that of the outer circumferential core 46. As a result thereof, a stator core 20E can be obtained in which roundness is increased, and eddy current loss is reduced.

Because the rib members 30 are welded to the outer circumferential core 46, which has greater circumferential rigidity, the occurrence of strain that results from welding the rib members 30 can be suppressed, and reductions in the roundness of the outer circumferential core 46 can be suppressed.

Moreover, in Embodiment 12 above, the inner circumferential core 47, which is not divided circumferentially, has been used, but an inner circumferential core that is divided into a plurality of segments circumferentially may alternatively be used. In that case, the inner circumferential core is configured by butting together side surfaces of inner circumferential core segments that are configured into a circular arc shape so as to be arranged into an annular shape.

In Embodiment 12 above, the rib members 30 have been used, but similar or identical effects can be achieved using rib members from other embodiments.

In Embodiment 12 above, rigidity in the circumferential direction of the outer circumferential core 46 is increased by using a magnetic steel sheet that has a thick sheet thickness, but the means for increasing the rigidity in the circumferential direction of the outer circumferential core 46 is not limited to using a magnetic steel sheet that has a thick sheet thickness. If, for example, the outer circumferential core 46 is produced by fixing laminated core strips by crimping, then the rigidity in the circumferential direction of the outer circumferential core 46 can be increased by increasing the number of crimped portions, and by increasing crimping strength. Furthermore, if the outer circumferential core 46 is produced by fixing laminated core strips by gluing, then the rigidity in the circumferential direction of the outer circumferential core 46 can be increased by using an adhesive that has greater adhesive strength, or by widening the bonding area to increase adhesive strength. If the outer circumferential core 46 is produced by welding laminated core strips, then the rigidity in the circumferential direction of the outer circumferential core 46 can be increased by increasing the number of weld portions, by deepening weld penetration depth in the weld portions, or by widening the welded surface area to increase weld strength.

In silicon steel sheets, silicon is added to iron, which is advantageous from a cost perspective, to control alignment of crystal orientation and width of magnetic domains, and if silicon steel sheets are used as the magnetic steel sheets, then it is preferable to use a silicon steel sheet in the outer circumferential core that has reduced silicon content compared to the inner circumferential core. For example, a silicon steel sheet that has a silicon content from 1% to 2% can be used in the outer circumferential core, and a silicon steel sheet that has a silicon content from 2.5% to 3.5% can be used in the inner circumferential core. Because the occurrence of blowholing can thereby be suppressed when the rib members are welded to the outer circumferential core, weld strength is stabilized, enabling a stator core that has more stable strength to be achieved. Because a silicon steel sheet that has higher silicon content is used in the inner circumferential core, core loss can be reduced.

A method for manufacturing the stator core 20 from Embodiment 1 will now be explained, but the stator cores in other embodiments can also be manufactured in a similar manner.

### Embodiment 13

FIG. 36 is a flow diagram that shows a stator core manufacturing method according to Embodiment 13 of the present invention.

First, annular core strips 15 are punched out of a magnetic steel sheet such as an electromagnetic steel sheet (Step 200). Next, a set number of the punched core strips 15 are laminated, and the laminated core strips 15 are fixed together by crimping, gluing, etc., (Step 201). The laminated core strips 15 are thereby integrated to produce the annular laminated core 21 that is shown in FIG. 5. Next, the rib members 30 are disposed on the outer circumferential surface of the laminated core 21 such that longitudinal directions of the rib members 30 are oriented in an axial direction, and the joining portions 32 are joined to the laminated core 21 by laser welding (Step 202). The stator core 20 that is shown in FIG. 3 is produced thereby.

Next, an inner circumferential surface of the laminated core 21 to which the rib members 30 have been welded is cut (Step 203). In this cutting step, an inner circumferential surface of each of the teeth 23 is cut using the bolt passage portion 33 for positioning, such that the inner circumferential surface of the laminated core 21 becomes a curved surface that contacts an identical cylindrical plane that is centered around the axial center of the laminated core 21.

In the manufacturing method according to Embodiment 13, because a cutting step is included in which the inner circumferential surface of the laminated core 21 to which the rib members 30 have been welded is cut, deterioration in the roundness of the laminated core 21, i.e., deterioration in the roundness of the stator core 20, due to welding stress that arises in the laminated core 21 in the rib member joining step at Step 202 is ameliorated.

Moreover, in Embodiment 13, the inner circumferential surface of the laminated core 21 is cut in the cutting step at Step 203, but the outer circumferential surface of the laminated core 21 may alternatively be cut such that the outer circumferential surface of the laminated core 21 lies on an identical cylindrical plane that is centered around the axial center of the laminated core 21. In addition, both the inner circumferential surface and the outer circumferential surface of the laminated core 21 may alternatively be cut. The laminated core 21 is joined together with the rib members 30 by laser welding in the rib member joining step at Step 202, but the rib members 30 and the laminated core 21 may alternatively be joined together by TIG welding, brazing, etc.

### Embodiment 14

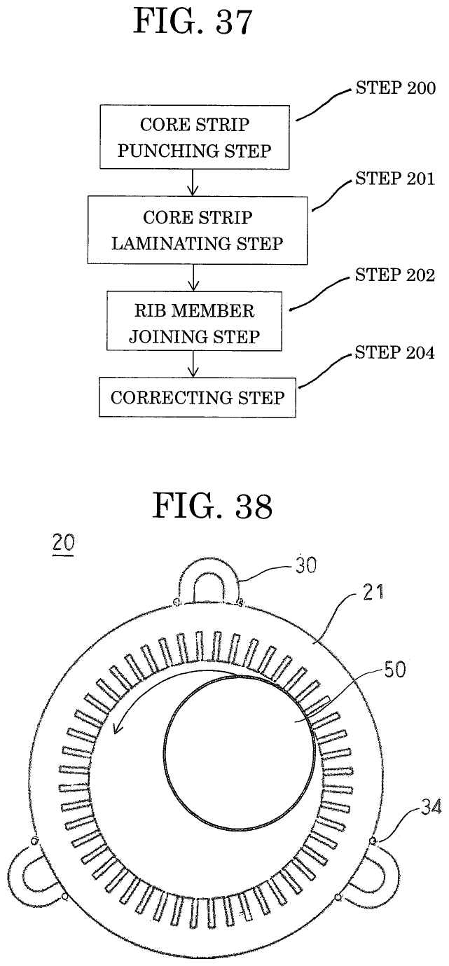

FIG. 37 is a flow diagram that shows a stator core manufacturing method according to Embodiment 14 of the present invention, and FIG. 38 is a schematic diagram that explains a correcting step in the stator core manufacturing method according to Embodiment 14 of the present invention.

First, annular core strips 15 are punched out of a magnetic steel sheet such as an electromagnetic steel sheet (Step 200). Next, a set number of the punched core strips 15 are laminated, and the laminated core strips 15 are fixed together by crimping, gluing, etc., (Step 201). The laminated core strips 15 are thereby integrated to produce the annular laminated core 21 that is shown in FIG. 5. Next, the rib members 30 are disposed on the outer circumferential surface of the laminated core 21 such that longitudinal directions of the rib members 30 are oriented in an axial direction, and the joining portions 32 are joined to the laminated core 21 by laser welding (Step 202). The stator core 20 that is shown in FIG. 3 is produced thereby.

Next, roundness of the stator core 20 is corrected (Step 204). In this correcting step, the bolt passage portions 33 are used for positioning. As shown in FIG. 38, the stator core 20 is made to revolve around a circle of set radius that is centered around the axial center of the stator core 20 while allowing the cylindrical roundness correcting tool 50 to rotate on its axis. Portions of the inner circumferential surface of the laminated core 21 that have sunken radially inward due to welding stress are thereby deformed by the roundness correcting tool 50 so as to be displaced radially outward, improving the roundness of the laminated core 21, i.e., the roundness of the stator core 20. Moreover, the radius of the roundness correcting tool 50 and the radius of the revolving path are set from the design value of the radius of the inner circumferential surface of the stator core 20 as circumstances require.

In the manufacturing method according to Embodiment 14, because a correcting step is included in which the roundness of the inner circumferential surface of the stator core 20 is corrected, deterioration in the roundness of the laminated core 21 due to welding stress that arises in the laminated core 21 in the rib member joining step at Step 202 is ameliorated.

### Embodiment 15

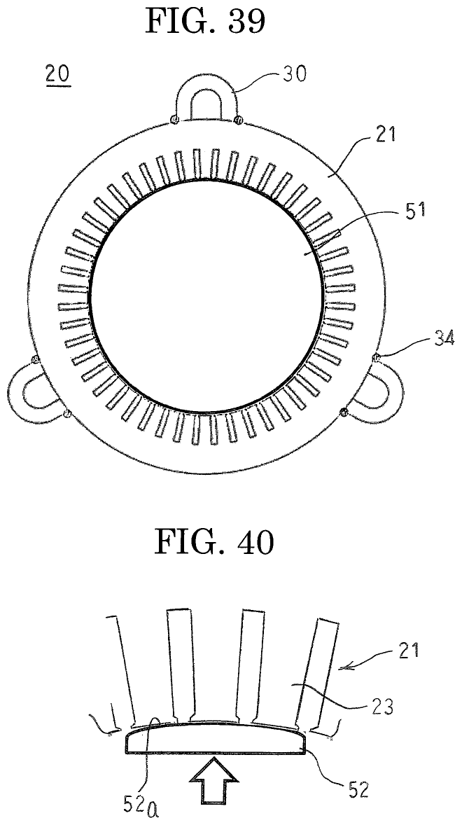

FIG. 39 is a schematic diagram that explains a step of correcting in a stator core manufacturing method according to Embodiment 15 of the present invention.

A stator core manufacturing method according to Embodiment 15 is similar or identical to that of Embodiment 14 except that a correcting step at Step 204 is different.

In this correcting step, as shown in FIG. 39, a cylindrical roundness correcting tool 51 is press-fitted into a laminated core 21 to which rib members 30 have been welded. The inner circumferential surface of the laminated core 21 is thereby deformed so as to conform to the outer circumferential surface shape of the roundness correcting tool 51, improving the roundness of the laminated core 21, i.e., the roundness of the stator core 20, which has deteriorated due to welding stress. Moreover, the radius of the roundness correcting tool 51 is set to the design value of the radius of the inner circumferential surface of the stator core 20.

### Embodiment 16

FIG. 40 is a schematic diagram that explains a step of correcting in a stator core manufacturing method according to Embodiment 16 of the present invention.

A stator core manufacturing method according to Embodiment 16 is similar or identical to that of Embodiment 11 except that a correcting step at Step 204 is different.

In this correcting step, as shown in FIG. 40, a roundness correcting tool 52 that has a pressing surface 52a that is formed so as to have a set curved surface shape is pressed against the inner circumferential surface of the laminated core 21 to which the rib members 30 have been welded while moving circumferentially. The inner circumferential surface of the laminated core 21 is thereby deformed so as to conform to the pressing surface 52a of the roundness correcting tool 52, improving the roundness of the laminated core 21, i.e., the roundness of the stator core 20, which has deteriorated due to welding stress. Moreover, the pressing surface 52a is formed so as to have a curved surface that has the design value of the radius of the inner circumferential surface of the stator core 20 as a radius of curvature. Furthermore, the roundness correcting tool 52 is moved radially outward until the pressing surface 52a is at a distance that is equal to the above-mentioned set value of the radius of the laminated core 21 from the axial center.

### Embodiment 17

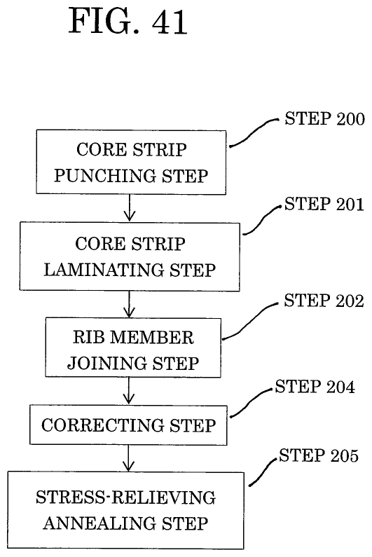

FIG. 41 is a flow diagram that shows a stator core manufacturing method according to Embodiment 17 of the present invention.

First, annular core strips 15 are punched out of a magnetic steel sheet such as an electromagnetic steel sheet (Step 200). Next, a set number of the punched core strips 15 are laminated, and the laminated core strips 15 are fixed together by crimping, gluing, etc., (Step 201). The laminated core strips 15 are thereby integrated to produce the annular laminated core 21 that is shown in FIG. 5. Next, the rib members 30 are disposed on the outer circumferential surface of the laminated core 21 such that longitudinal directions of the rib members 30 are oriented in an axial direction, and the joining portions 32 are joined to the laminated core 21 by laser welding (Step 202). The stator core 20 that is shown in FIG. 3 is produced thereby.

Next, roundness of the stator core 20 is corrected (Step 204). In this correcting step, as shown in FIG. 39, the roundness of the stator core 20 is corrected by press-fitting a cylindrical roundness correcting tool 51 into a laminated core 21 to which rib members 30 have been welded. Next, the stator core 20 into which the roundness correcting tool 51 has been inserted is heated to a set temperature (Step 205). In this stress-relieving annealing step (Step 205), internal stresses that have arisen inside the stator core 20 due to welding the rib members 30 and press-fitting the roundness correcting tool 51 are removed. Stabilization of quality of the weld portions between the laminated core 21 and the rib members 30 can be achieved thereby. The stress-relieving annealing step is performed in a state in which the roundness correcting tool 51 is pressed against the inner circumferential surface of the laminated core 21. Because the internal stresses are removed in a state in which the roundness of the stator core 20 has been corrected in this manner, the corrected roundness of the stator core 20 is maintained even if the roundness correcting tool 52 is removed.

Moreover, in each of the above embodiments, three rib members are disposed on the outer circumferential portion of the laminated core at a uniform angular pitch, but the number and disposed positions of the rib members are not limited thereto, and may be set so as to align with the positions of fixing with external parts as circumstances require.

### EXPLANATION OF NUMBERING

15, 16 CORE STRIP; 20, 20A, 20B, 20C, 20D, 20E, 20F STATOR CORE; 21, 21A, 21B, 21C LAMINATED CORE; 22 BACK YOKE; 23 TOOTH; 24, 24a, 25 POSITIONING GROOVE; 30, 30A, 30B, 30C, 30D, 30E, 30F, 30G, 30H, 30I, 30J RIB MEMBER; 33, 33a BOLT PASSAGE PORTION; 35 FIRST FLAT SURFACE (RADIAL MOUNTING POSITION REFERENCE PORTION); 36 SECOND FLAT SURFACE; 37 NOTCH (RADIAL MOUNTING POSITION REFERENCE PORTION); 39 WELD PORTION; 40 LAMINATED CORE; 41 BACK YOKE; 42 TOOTH; 44 END PLATE; 46 OUTER CIRCUMFERENTIAL CORE; 47 INNER CIRCUMFERENTIAL CORE; 48 BACK YOKE PORTION; 49 TOOTH; 50, 51, 52 ROUNDNESS CORRECTING TOOL.

1. A rotary electric machine stator core comprising:
a laminated core in which a plurality of teeth are arranged circumferentially so as to each protrude radially inward from an inner circumferential surface of an annular back yoke; and
a plurality of rib members that each have a bolt passage portion, that are joined to an outer circumferential surface of said laminated core such that a bolt insertion direction of said bolt passage portion is oriented in an axial direction, and that are disposed so as to be spaced apart from each other in a circumferential direction,
wherein:
each of said plurality of rib members is formed so as to have an inner circumferential surface shape in which two side portions in a circumferential direction of an inner circumferential surface contact an outer circumferential surface of said laminated core, said rib members being fixed by welding to said laminated core in a state in which said two side portions in said circumferential direction of said inner circumferential surface contact said outer circumferential surface of said laminated core.

2. The rotary electric machine stator core according to claim 1, wherein two side surfaces or one side surface in a circumferential direction of at least one rib member among said plurality of rib members comprises a flat surface that is positioned on a plane that includes an axial center of said laminated core.

3. The rotary electric machine stator core according to claim 1, wherein a radial mounting position reference portion is formed on an apex portion of at least one rib member among said plurality of rib members.

4. The rotary electric machine stator core according to claim 3, wherein said radial mounting position reference portion is a flat surface that is tangential to a cylindrical plane that is centered around said axial center of said laminated core.

5. The rotary electric machine stator core according to claim 3, wherein said radial mounting position reference portion is a V-shaped notch that has a groove direction in an axial direction.

6. The rotary electric machine stator core according to claim 1, wherein each of said plurality of rib members is formed so as to be longer than an axial length of said laminated core, and is joined to said laminated core such that a first axial end thereof is flush with a first axial end of said laminated core, or such that two axial ends thereof protrude outward at two axial ends of said laminated core.

7. The rotary electric machine stator core according to claim 1, wherein:
a positioning groove is formed on an outer circumferential surface of said laminated core so as to correspond to a disposed position of each of said plurality of rib members; and
each of said plurality of rib members is joined to said laminated core in a state of being fitted into said positioning groove.

8. (canceled)

9. The rotary electric machine stator core according to claim 1, wherein each of said plurality of rib members is fixed by welding to said laminated core discontinuously in an axial direction.

10. The rotary electric machine stator core according to claim 1, wherein said laminated core is configured into an annular shape by laminating a belt-shaped magnetic steel sheet in a helical shape.

11. The rotary electric machine stator core according to claim 10, further comprising an end plate that is disposed so as to be laminated on a first axial end of said laminated core,
said end plate being constituted by a single annular magnetic steel sheet that is thicker than said belt-shaped magnetic steel sheet.

12. The rotary electric machine stator core according to claim 1, wherein said laminated core comprises:
an inner circumferential core in which said plurality of teeth are arranged circumferentially so as to each protrude radially inward from an inner circumferential surface of an annular back yoke portion; and
an annular outer circumferential core that is disposed circumferentially outside said inner circumferential core so as to be in contact with said inner circumferential core, said outer circumferential core constituting said back yoke together with said back yoke portion.

13. The rotary electric machine stator core according to claim 12, wherein said inner circumferential core is divided into a plurality of segments in a circumferential direction.

14. The rotary electric machine stator core according to claim 12, wherein circumferential rigidity of said outer circumferential core is greater than circumferential rigidity of said inner circumferential core.

15. The rotary electric machine stator core according to claim 14, wherein a thickness of a magnetic steel sheet that constitutes said outer circumferential core is thicker than a thickness of a magnetic steel sheet that constitutes said inner circumferential core.

16. The rotary electric machine stator core according to claim 12, wherein silicon content of a magnetic steel sheet that constitutes said outer circumferential core is lower than silicon content of a magnetic steel sheet that constitutes said inner circumferential core.

17. A method for manufacturing a rotary electric machine stator core comprising:
a laminated core in which a plurality of teeth are arranged circumferentially so as to each protrude radially inward from an inner circumferential surface of an annular back yoke; and
a plurality of rib members that are each solid bodies that have a bolt passage portion, that are joined to an outer circumferential surface of said laminated core such that a bolt insertion direction of said bolt passage portion is oriented in an axial direction, and that are disposed so as to be spaced apart from each other in a circumferential direction,
said method for manufacturing said rotary electric stator core comprising:
a rib member joining step in which said plurality of rib members are joined to said outer circumferential surface of said laminated core; and
a cutting step in which at least one of an inner circumferential surface and an outer circumferential side of said laminated core to which said plurality of rib members have been joined is cut,
wherein:
said plurality of rib members are produced into prisms that have a U shape;
a positioning groove is formed at each position where said plurality of rib members are disposed on said outer circumferential surface of said laminated core so as to have a groove direction oriented in an axial direction so as to extend from a first axial end to a second axial end; and
in said rib member joining step, a pair of leg portions of said U shape of each of said plurality of rib members are inserted into each of said positioning grooves in a state of being elastically deformed such that spacing between said pair of leg portions is narrowed, said elastic deformation of said pair of leg portions is released after said pair of leg portions contacts a floor portion of said positioning groove, and said rib member is fixed to said positioning groove by a force of recovery of said pair of leg portions.

18. A method for manufacturing a rotary electric machine stator core comprising:
a laminated core in which a plurality of teeth are arranged circumferentially so as to each protrude radially inward from an inner circumferential surface of an annular back yoke; and
a plurality of rib members that are each solid bodies that have a bolt passage portion, that are joined to an outer circumferential surface of said laminated core such that a bolt insertion direction of said bolt passage portion is oriented in an axial direction, and that are disposed so as to be spaced apart from each other in a circumferential direction,
said method for manufacturing said rotary electric stator core comprising:
a rib member joining step in which said plurality of rib members are joined to said outer circumferential surface of said laminated core; and
a correcting step in which roundness of said laminated core is corrected by pressing a tool against an inner circumferential surface of said laminated core to which said plurality of rib members have been joined,
wherein:
said plurality of rib members are produced into prisms that have a U shape;
a positioning groove is formed at each position where said plurality of rib members are disposed on said outer circumferential surface of said laminated core so as to have a groove direction oriented in an axial direction so as to extend from a first axial end to a second axial end; and
in said rib member joining step, a pair of leg portions of said U shape of each of said plurality of rib members are inserted into each of said positioning grooves in a state of being elastically deformed such that spacing between said pair of leg portions is narrowed, said elastic deformation of said pair of leg portions is released after said pair of leg portions contacts a floor portion of said positioning groove, and said rib member is fixed to said positioning groove by a force of recovery of said pair of leg portions.

19. The method for manufacturing a rotary electric stator core according to claim 18, further comprising a stress-relieving annealing step in which said laminated core is heated in a state of being pressed by said tool, said stress-relieving annealing step being performed subsequent to said correcting step.

20. (canceled)

21. (canceled)
